(19) United States
(12) Patent Application Publication
(10) Pub. No.: US 2006/0286348 A1
(43) Pub. Date: Dec. 21, 2006

(54) Object

(76) Inventor: Hartmut Sauer, Wilnsdorf (DE)

Correspondence Address: FISH & RICHARDSON PC, P.O. BOX 1022, MINNEAPOLIS, MN, 55440-1022, US

(21) Appl. No.: 10/553,294

(22) PCT Filed: Apr. 15, 2004
(86) PCT No.: PCT/IB04/50458

§ 371 Date: Oct. 14, 2005

(30) Foreign Application Priority Data
Apr. 16, 2003 (DE) 103 17 796.5
Jan. 9, 2004 (DE) 102004001613.5

(51) Int. Cl. B05D 3/04; B05D 1/18; B05D 3/10; B32B 15/08; B32B 27/20

(52) U.S. Cl. 428/141; 427/307; 427/437; 427/443.1; 427/304; 428/457; 428/301.1; 428/702

(57) ABSTRACT

Article whose surface exhibits a composite material in full or in parts, the composite material consisting of a non-metallic substrate containing at least one polymer, and a metallic layer present thereon and deposited without external current, having an adhesive strength of at least 4 N/mm², the boundary layer present between the non-metallic substrate and the metallic layer exhibiting a calcium content, determined by EDX analysis of a microtome section, of maximum 0.5 % by wt., based on an analysis area of 1×1 μm whose centre runs through the boundary layer.

The present invention relates to an article whose surface consists of a composite material in full or in parts, the composite material consisting of a polymer, and a metallic layer present thereon.

Such articles are known and used in particular in the decorative area such as e.g. chrome-plated articles made from ABS (acrylic/butadiene/styrene polymers) or polymer blends, in particular decorative mouldings, showerheads, radiators grills of motor vehicles, coffee pots.

Such composite materials do not exhibit any noteworthy adhesive strength such that—independently of the decorative properties—such articles are incapable of executing any technical functions in the sense of protection against wear and tear, anticorrosion protection, reinforcement, protection against mechanical, thermal and/or chemical stress.

Recently, the possibilities have been considered of developing composite materials or surfaces of such composite materials with such functions.

One process for the production of such layers is thermal spraying. In this case, metallic particles are heated and applied in an accelerated manner onto the substrate to be coated. In this way, metallic layers can be produced on plastics. By means of this process, it is possible, however, to coat only structural parts with a simple geometry. The main disadvantages of this process consist, moreover, of the fact that the layers exhibit a high porosity, a high inherent stress, a high layer thickness and insufficient adhesion for structural parts subject to high mechanical stresses.

A further possibility for producing such composite materials consists of the vapour deposition of metal on plastic in a vacuum (CVD/PVD process). In this way, closed, metallic coatings are applied onto non-metallic substrates such as e.g. plastics. However, this process is economically unsuitable for structural parts with fairly large dimensions. Moreover, structural parts with indentations or voids are not completely metallised. The articles produced in this way have a metal layer with a thickness of maximum 3 μm which is insufficient for many industrial applications. Moreover, these composite layers have only a very low adhesive strength.

A wide-spread field of application for this vapour deposition technique is coating of plastic films, e.g. for food packaging. Thus, DE 198 49 661 A1 discloses the vapour deposition of aluminium onto a special polyester film in such a way that it exhibits a strong oxygen barrier, a high gloss and a low coefficient of friction. The adhesive strengths of up to 3 N/mm indicated therein, however, are too low to withstand to a functional application, subject to mechanical stress, of the metallised film.

In DE 43 12 926 A1, a process for the improvement of the adhesive strength of dental metal-polymer composite layers is described. For this purpose, a metallic substrate onto which a polymer has already been applied is irradiated with a special Te—CO₂ laser. If necessary, an adhesive agent is additionally used. A metallisation of plastic substrates is not described here.

DE 42 11 712 A1 also describes the irradiation of the surface of a substrate in order to improve the adhesive strengths with an Eximer laser. A PET (polyethylene terephthalate) film is irradiated with this special laser in order to subsequently apply a ferromagnetic metal layer by vapour deposition within the framework of a PVD process. Such films are used as audio or video recording medium, among other things.

In addition, a process exists for special plastics in the case of which the articles to be coated are first caused to swell with suitable substances and subsequently etched chemically. The adhesive strengths of the metal layer applied onto the plastic, which are thus achieved, amount to maximum 2 N/mm².

A major disadvantage of this process is the considerable environmental pollution by the two chemical treatment agents such that this process can not be much longer for considerations of environmental politics.

A process, which has been developed further, for metallising polyamides which is based on the principle, described above, of causing the surface of the plastic substrate to swell but does not provide for pickling with chromium sulphuric acid is presented in an article by G. D. Wolf and F. Fünger “Metallisierte Polyamid-Spritzguβteile” (metallised polyamide injection-moulded parts), Kunststoffe, 1989, pages 442-447. The surface of the amorphous polyamide is treated with an organometallic activator solution. Subsequently, a conventional plating process for depositing a chemical nickel layer is carried out.

A disadvantage of this type of surface treatment which is based on a chemical reaction of the treatment solution with the substrate is that the swollen surfaces are highly sensitive to environmental influences such as e.g. dust embedments. Moreover, the polyamide to the treated must be amorphous since partially crystalline or crystalline polyamides are not attacked by the method presented. Consequently, this method is a time-consuming, expensive process which has only limited use in order to achieve adhesive composite layers between the polymer substrate and metal layer.

Moreover, it is known from the thesis by H. Sauer, Siegen 1999 to produce composite materials of a plastic and a metal layer present thereon, the plastic surface, being roughened, before the application of the metallic layer, by using a blasting agent and subsequently treated with a special ethanol/calcium carbonate suspension.

Such composite materials exhibit an extraordinarily high adhesive strength of the metal layer on the plastic substrate.

However, no fairly large surfaces can be produced on an industrial scale by the process described therein. Moreover, the layers which can be obtained in this way have the disadvantage that small quantities of calcium carbonate remain in the boundary layer between the plastic substrate and the metal layer such that a “predetermined breaking point” is formed. This “predetermined breaking point” leads to the adhesive strength varying greatly at different points of an article. These deviations cause the points with the lowest adhesive strengths to cause to early defects in the case of articles subject to high mechanical stress.

The object of the present invention consists of the provision of an article that can be subjected to extreme mechanical stress and whose surface exhibits, partly or as a whole, a composite material consisting of at least one polymer and one metal layer, which composite material overcomes the disadvantages of the state of the art described above.

The object is achieved according to the invention by way of an article whose surface exhibits a composite material, in full or in parts, the composite material consisting of a non-metallic substrate containing at least one polymer, and a metallic layer present thereon and deposited without external current, having an adhesive strength of at least 4 N/mm², the boundary layer present between the non-metallic substrate and the metallic layer exhibiting a calcium content, determined by EDX analysis of a microtome section, of maximum 0.5% by wt., based on an analysis area of 1×1 μm, whose centre runs through the boundary layer.

It should be noted that, in a general embodiment, the non-metallic substrate essentially does not contain any particles of metal oxides or metals. This means that no corresponding particles are detectable analytically in the substrate in the microtome section at a depth of more than 10 μm below the boundary between the metallic layer and the non-metallic layer.

On the other hand, it is possible for the boundary layer to contain particles of metal oxides or metals in small quantities up to a depth of 10 μm, which originate e.g. from the blasting agent for roughening of the non-metallic substrate surface, for example.

In contrast thereto, it is possible in special embodiments in which polymers reinforced with glass fibre are used as non-metallic substrate, to detect, in the entire non-metallic substrate, particles of metal oxides in the microtome section. Commercial examples of such plastics reinforced with glass fibre are Grivory HTV-6H1, Grivory HAT-PPA or Grivory GM-4H from EMS-GRIVORY. Commercial examples of plastics reinforced with ceramics are Ryton BR111 and Ryton BR111 BL from Chevron Phillips Chemical Company LP.

Depending on the polymer-containing material used—the article can be produced by so-called rapid prototyping processes, in particular by stereolithography or by laser sintering. In this way, complex shapes can be produced within a short time which are coated evenly, contour-accurately with the metallic layer deposited without external current without reinforcements being observed in the edge area or weaknesses within the area of indentations or undercuts.

To determine the calcium content and the roughness values Rₐ and R_{z}, a specimen is taken from the article according to the invention and a microtome section is produced according to the method detailed below.

In a further embodiment, an object according to the invention is preferred whose surface exhibits a composite material in full or in parts, this composite material exhibiting a first non-metallic layer and a second metallic layer applied thereon, and
a) the surface of the article not being chemically pretreated before the application of the metallic layer deposited without electric current; and
b) the metallic layer not being applied by thermal spraying, CVD, PVD or laser treatment.

Chemical pretreatment should be understood here and subsequently, as a delimitation to mechanical treatments, any treatment of a substrate surface which is carried out by pickling, etching, swelling, vapour deposition, plasma treatment, laser treatment or similar methods and in the case of which a change to the surface is caused by a chemical reaction.

In contrast to the articles of the state of the art metallised after chemical pretreatment, the articles according to the present invention exhibit a rough, sharp-edged boundary layer between the non-metallic layer and the metallic layer applied without external current. These sharp edged indentations and undercuts of the boundary layer are clearly recognisable as edged surface contours, e.g. in a microtome section analysis whose execution is described in the following. Thus, they can be distinguished from the rather roundish, and in any case rounded-off contours which are formed by a chemical pretreatment (FIG. 2).

When making the microtome section, there is the particular difficulty that the boundary surface between the substrate and the surface can be very rapidly destroyed or detached by the treatment. To avoid this, a new separation disc from Struer, type 33TRE DSA No. 2493 is used for each microtome section. Moreover, care must be taken to ensure that the application pressure which is transferred from the separation disc onto the substrate coating is directed such that the force flows from the coating in the direction towards the substrate. During the separation, care must be taken to ensure that the application pressure is kept as low as possible.

The specimen to be examined is placed into a transparent embedding mass (Epofix putty, obtainable from Struer). The embedded specimen is ground in a table grinding machine from Struer, type KNUTH-ROTOR-2. Different abrasive papers with silicon carbide and different granulations are used for this purpose. The exact sequence is as follows:

| | Granulation | Time |
|---|---|---|
| First grinding treatment | P800 | approximately 1 min |
| Second grinding treatment | P1200 | approximately 1 min |
| Third grinding treatment | P2400 | approximately 30 sec |
| Fourth grinding treatment | P 4000 | approximately 30 sec |

During the grinding process, water is used in order to remove the grinding particles. The tangential force which arises at the cross-section and by friction is directed in such a way that the metallic layer is pressed against the non-metallic substrate. In this way, the metallic layer is effectively prevented from detaching itself from the non-metallic substrate during the grinding process.

Subsequently, the specimen thus treated is polished with a motor-driven preparation device of the DAP-A type from Struer. For this process, it is not the usual specimen mover which is used but the specimen is instead polished exclusively by hand. Depending on the substrate to be polished, a torque of between 40 to 60 rpm/min and an application force between 5 and 10 N is used.

The microtome section is subsequently subjected to SEM micrography. For the determination of the boundary line enlargement, the boundary line of the layer between the non-metallic substrate and the metallic surface is determined with a 10,000 fold magnification. For the evaluation, the OPTIMAS program from Wilhelm Mikroelektronik is used. The result is determined in the form of the X-Y value pairs which describe the boundary line between the substrate and the layer. To determine the boundary layer magnification in the sense of the present invention, a distance of at least 100 μm is required. The course of the boundary layer needs to be determined with at least 10 measuring points per μm in this case. The boundary layer magnification is determined from the quotient of the true length by the geometric length. The geometric length corresponds to the distance of the measured distance, i.e. between the first and the last measuring point. The true length is the length of the line which passes through all the measuring points recorded.

The surface roughness value Rₐ is determined according to the standard DIN 4768/ISO 4287/1 again using the X-Y value pairs recorded before.

The Rₐ value is a measure reproducible by measuring techniques of the roughness of surfaces, profile runaways (i.e. extreme troughs or elevations) being largely ignored in the surface integration.

The adhesive strengths (indicated in N/mm²) of the composites according to the invention are determined exclusively by way of the frontal tensile test according to DIN 50160:

The frontal tensile test (vertical tensile test) according to DIN 50160 has been used for many years for testing semiconductors, the determination of the adhesive tensile strength of thermally sprayed layers and in various coating techniques.

For the determination of the adhesive strength by the frontal tensile test, the layer/substrate composite to be tested is bonded between two test dies and subjected to a load under a single-axis force up to rupture (compare FIG. 1). If the adhesive strength of the adhesive is greater than that of the coating and the rupture occurs between the layer and the substrate, it is possible to calculate the adhesive strength according to the equation

$${σ}_{H exp} = \frac{{F}_{max}}{{A}_{G}}$$

(with σ_{H exp}: experimentally determinable adhesive strength, Fₘₐₓ: maximum force on rupture of the composite and A_{G}: geometric surface of rupture).

In the case of the basic materials according to the state of the art which hold a metallic layer on a microstructured plastic surface, traces of calcium carbonate are detectable by the production process. These contaminants are introduced by the necessary pretreatment using a suspension of ethanol and calcium carbonate. A possible explanation of the improved homogeneity of the adhesive strength in the case of articles according to the present invention can be considered as being that the remaining proportion of foreign components has been reduced in such a way that it no longer acts as a separator or as a separating layer between the plastic surface and the metallic layer.

The determination of the proportion of calcium in the boundary surface is carried out by EDX spectroscopy.

Examples of such an article according to the invention are pump housings and the corresponding rotors (pump wheel) of fuel pumps for the motor vehicle industry. These articles are those made of thermoplastics, in particular of polyoxymethylene (POM) and polyphenylene sulphide (PPS). The phenol resin PF is used particularly preferably. Following the pretreatment described above, these fuel pump parts are coated without external current with a chemical nickel layer in a thickness of 5 μm. The corresponding articles according to the invention are characterised by a particularly high protection against corrosion and wear and tear. The service lives of the articles thus produced are increased by a factor of 100—compared with the state of the art.

In a preferred embodiment of the present invention, the boundary layer between the non-metallic layer and the metallic layer exhibits a roughness with an R_{z} value of maximum 35 μm.

The R_{z} value is a measure of the average vertical surface fragmentation.

According to a further embodiment of the present invention, the non-metallic substrate contains at least one fibre-reinforced polymer, in particular a polymer reinforced with carbon fibre and the diameter of the fibre is less than 10 μm. According to a further embodiment of the present invention which is also preferred, the boundary present between the non-metallic substrate and the metallic layer exhibits a roughness with an R_{z} value of maximum 100 μm and the non-metallic substrate contains at least one fibre-reinforced polymer, in particular a polymer reinforced with glass fibre, the diameter of the fibre being more than 10 μm.

For the use of fibre-reinforced polymers whose fibre thickness amounts to more than 10 μm, in particular, it is important to achieve R_{z} values which are as low as possible. In the case of this combination it is, surprisingly, possible to achieve high adhesive strengths with—in comparison with the large fibre diameters used—low R_{z} values.

Insofar as the composite materials are subject not only to thermal stresses but also to mechanical stresses, reinforced plastics, in particular plastics reinforced with carbon fibres (CRP), plastics reinforced with glass (GFP) and also plastics reinforced with aramite fibres or plastics reinforced with mineral fibres are used particularly preferably.

By providing these articles, a high rigidity of the resulting structural parts is achieved with a low weight which structural parts are of interest for industrial application because of their low cost. In particular, polymers reinforced with glass fibre used as a component of the non-metallic layer exhibiting fibres with a diameter of more than 10 μm are very cheap and easy to process. The fibre diameter has a strong influence on the roughness values such that, in the case of such materials according to the present invention, a roughness value Rₐ of maximum 10 μm is achieved. At the same time, it is possible according to the invention to achieve excellent values for the adhesive strength. In addition, the articles according to the invention have a high homogeneity of adhesion. This makes it possible for the first time to substantially increase the service life of the structural part subject to stress since even a local delamination of the composite material leads to failure of the structural part as a whole. Of particular weight is the advantage in the case of structural parts with a surface covered by the layer material of more than 10 dm², i.e. in the case of large structural parts or structural parts with a large surface area.

In this way, articles with a high rigidity with a very low weight are obtained which exhibit an excellent adhesion of the metallic layer. This property profile is of interest for a wide area of technical applications such as e.g. the aircraft and space industry and for the motor vehicle industry.

According to a preferred embodiment, the non-metallic substrate is simultaneously the surface of the article. Preferably, these surfaces are based on a polymeric material. Fibre-reinforced plastics, thermoplastics and other industrially used polymers are to be mentioned as being particularly preferred.

Similarly, however, it is also possible to use articles whose non-metallic substrate is not the surface of the article. Thus, the article can consist of a metallic or ceramic material which is coated with a non-metallic substrate which contains at least one polymer. Examples of such substrates are coated structural parts (e.g. explosion protection for coated articles and anodised or hard anodised aluminium structural parts with a polymer layer present on the conversion layer.

According to a preferred embodiment, the standard deviation of the adhesive strength of the metal layer at six different measured value points distributed over the surface of composite material amounts to maximum 25%, in particular maximum 15%, of the arithmetic mean.

In this way, an even higher mechanical resistance to stress of the resulting structural parts is guaranteed.

The polymer of the non-metallic layer is preferably selected from the group of polypropylene, polytetrafluoroethylene, polyamide, polyethylene, polyvinyl chloride, polystyrene, epoxy resins, polyether ether ketone, polyoxymethylene, polyformaldehyde, polyacetal, polyurethane, polyether imide, polyphenyl sulphone, polyphenylene sulphide, polyarylamide, polycarbonate and polyimide.

In those cases in which the non-metallic layer contains either polypropylene and/or polytetrafluoroethylene, adhesive strengths of at least 5 N/mm² are achieved. This represents an excellent value, in particular in combination with the high homogeneity of the adhesive strength which could not be achieved previously.

It is thus possible for the first time to provide articles with a composite material which exhibit particular properties with respect to their wettability, their permeability for certain substances or also with respect to their compatibility with blood and blood plasma. A possible application for such articles of polytetrafluoroethylene might be, for example, in medical technology as a membrane for pumps or in fuel cell technology.

According to a further embodiment of the present invention, which is also preferred, the metallic layer deposited without external current is a metal alloy or metal dispersion layer

In this way, articles with a composite material can be provided for the first time which exhibit an excellent adhesion of the non-metallic layer to the non-metallic layer. The homogeneity of the adhesion of the metallic layer also plays an important part for the suitability of these articles as structural parts subject to high stress for industrial machines. This controlled selection of the non-metallic substrate and the metallic layer present thereon allows an accurate adjustment of the property profile to the conditions of the field of use. It is thus important, for example, to adjust an accurately defined adhesive strength in the case of CFP rollers which are used in a length of between 1,000 and 12,000 mm, with a line load constant over their entire length, for the roller to withstand the requirements for the entire service life.

Particularly preferably, a copper, nickel or gold layer is applied onto the non-metallic substrate of the article according to the invention as a metal layer deposited without external current.

However, a metal alloy or metal dispersion layer deposited without external current can also be applied, preferably a copper, nickel or gold layer with embedded non-metallic particles. In this respect, the non-metallic particles may exhibit a hardness of more than 1,500 HV and may be selected from the group of silicon carbide, corundum, diamond and tetraboron carbide.

These dispersion layers consequently have other functions, apart from the properties described above; for example, the resistance to wear and tear, surface wetting and emergency operation properties of the articles according to the invention can be improved.

Also preferably, the non-metallic particles may exhibit friction-reducing properties and be selected from the group of polytetrafluoroethylene, molybdenum sulphide, cubic boron nitride and tin sulphide.

In a further particularly preferred embodiment of the present invention, a layer of aluminium, titanium or their alloys is applied onto the metallic layer, deposited without electric current, of the article according to the invention, the surface of the layer being anodically oxidised or ceramic coated.

Such layers of aluminium, titanium or their alloys oxidised or ceramic coated by the anodic route are known on metallic articles and are marketed under the trade name Hart-Coat® or Kepla-Coat®, for example, by AHC Oberflächentechnik GmbH & Co. OHG. These layers are characterised by a particularly high hardness and a high operating resistance and resistance to mechanical stresses.

Between the metallic layer of the article according to the invention deposited without electric current and the layer of aluminium, titanium or their alloys, one or several further metallic layers can be arranged.

The further metallic layers ranged between the layer deposited without electric current and the aluminium layer are selected according to the end purpose of use. The selection of such intermediate layers is well known to the expert and described e.g. in the book “Die AHC-Oberfläche—Handbuch für Konstruktion und Fertigung (The AHC surface—Handbook for construction and manufacture”) 4^{th} enlarged edition 1999.

It is also possible for the surface of such an article to be a ceramic oxide layer of aluminium, titanium or their alloys which is coloured black by foreign ion embedment.

The ceramic oxide layer of aluminium, titanium or their alloys which is coloured black by foreign ions is of particular interest for high value optical elements, in particular in the aircraft and aerospace industry.

The manufacture of ceramic oxide layers coloured black by foreign ion embedments has, for example, been described in U.S. Pat. No. 5,035,781 or U.S. Pat. No. 5,075,178. The manufacture of oxide ceramic layers on aluminium or titanium is described e.g. in EP 0 545 230 B1. The manufacture of anodically produced oxide layers on aluminium is described e.g. in EP 0 112 439 B1.

The articles of the present invention are obtained particularly preferably by means of a special process which comprises the following steps:
i. the surface of the non-metallic layer is not chemically pretreated before applying the metallic layer applied without electric current;
ii. the surface of the non-metallic layer is microstructured in a first step by means of a blasting agent;
ii. the metallic layer is subsequently applied by metal deposition without external current.

The articles according to the present invention exhibit, as composite material, first of all a non-metallic substrate which contains at least one polymer. To produce the composite material according to the invention, the surface of the non-metallic substrate is microstructured in a first step by means of a blasting treatment. The process used is described in DE 197 29 891 A1, for example. Inorganic particles resistant to wear and tear, in particular, are used as blasting agent. Preferably, these consist of copper-aluminium oxide or silicon carbide. It has proven advantageous in this respect that the blasting agent has a particle size of between 30 and 300 μm. Further suitable blasting agents are steel and aluminium of different composition and granulation, glass blasting beads, corundum, ceramic beads, polymer resins, silicon carbide, nut shells and other blasting agents know to the expert. It is further described therein that a metal layer can be applied by means of metal deposition without external current onto surfaces roughened in this way.

As the designation of the process already indicates, no electric energy is supplied from outside during the coating process in the case of the metal deposition without electric current but instead the metal layer is deposited exclusively by a chemical reaction. The metallisation of non-conductive plastics in a metal salt solution operating by chemical reduction requires a catalyst at the surface in order to interfere with the metastable equilibrium of the metal reduction bath there and to deposit metal on the surface of the catalyst. This catalyst consists of noble metal seeds such as palladium, silver, gold and occasionally copper which are added onto the plastic surface from an activator bath. However, an activation with palladium seeds is preferred for process technology reasons.

Essentially, the activation of the substrate surface takes place in two steps. In a first step, the structural part is immersed into a colloidal solution (activator bath). In this respect, the palladium seeds necessary for the metallisation and already present in the activator solution are adsorbed to the plastic surface. After seeding, the tin(II) and/or tin(IV) oxide hydrate which is additionally formed on immersion into the colloidal solution is dissolved by rinsing in an alkaline aqueous solution (conditioning) and the palladium seed is exposed as a result. After rinsing, nickel coating or copper coating can take place using chemical reduction baths.

This is effected in a bath maintained in metastable equilibrium by means of a stabiliser, which bath contains both the metal salt and the reducing agent. The baths for the nickel and/or copper deposition have the characteristic of reducing the metal ions dissolved therein at the seeds and to deposit elementary nickel or copper. In the coating bath, the two reactants must approach the noble metal seeds on the plastic surface. As a result of the redox reaction taking place in this way, the conductive layer is formed, the noble metal seeds absorbing the electrons of the reducing agents in this case and releasing them again when a metal ion approaches. In this reaction, hydrogen is liberated. After the palladium seeds have been coated with nickel and/or copper, the layer applied takes on the catalytic effect. This means that the layer grows together starting out from the palladium seeds until it is completely closed.

As an example, the deposition of nickel will be discussed in further detail here. During coating with nickel, the seeded and conditioned plastic surface is immersed into a nickel metal salt bath which permits a chemical reaction to take place within a temperature range of between 82° C. and 94° C. In general, the electrolyte is a weak acid with a pH of between 4.4 and 4.9.

The thin nickel coatings applied can be strengthened with an electrolytically deposited metal layer. Coating of structural parts with layer thicknesses of >25 μm is not economical because of the low rate of deposition of chemical deposition processes. Moreover, only a few coating materials can be deposited using the chemical deposition processes such that it is advantageous to make use of electrolytic processes for further industrially important layer materials. A further essential aspect consists of the different properties of layers chemically and electrolytically deposited with layer thicknesses of >25 μm, e.g. levelling, hardness and gloss. The bases of electrolytic deposition have been described e.g. in B. Gaida, “Einführung in die Galvanotechnik” (Introduction into electroplating) “E.G. Leuze-Verlag, Saulgau, 1988 or in H. Simon, M. Thoma, “Angewandte Oberflächentechnik für metallische Werkstoffe” (Applied surface technology for metallic materials) “C. Hanser-Verlag, Munich (1985).

Plastic parts which exhibit an electrically conductive layer as a result of a coating processes applied without electric current differ with respect to electrolytic metallisation only slightly from those of the metals. Nevertheless, a few aspects should not be disregarded in the case of the electrolytic metallisation of metallised polymers. As a result of the usually low conductive layer thickness, the current density must be reduced at the beginning of electrolytic deposition. If this aspect is ignored, a detachment and combustion of the conductive layer may occur. Moreover, care should be taken to ensure that undesirable layers of tarnish are removed by pickling baths particularly adapted for this purpose. Moreover, inherent stresses may lead to the destruction of the layer. In the case of deposits of nickel layers from an ammonia-containing bath, tensile stresses of the order of 400 to 500 MPa, for example, may occur. By means of additives such as saccharine and butine diol, a change to the structure of the nickel coatings in the form of a modified grain size and the formation of microdeformations may promote the decrease in internal stresses which may have a positive effect on a possible premature failure of the coating.

Examples of metal layers applied without external current are described in detail in the handbook of AHC Oberflächentechnik (“Die AHC-Oberfläche” Handbuch für Konstruktion und Fertigung, (“The AHC surface” Handbook for construction and manufacture”) 4^{th} edition 1999).

In addition, one or several further layers, in particular metallic, ceramic and crosslinked or cured polymer layers can be arranged on the metallic layer of the article according to the invention.

It is thus possible, for example to apply a further electrolytically deposited nickel layer onto a nickel layer deposited without electric current as metallic layer of the present invention and to deposit a chromium layer thereon. The surfaces thus obtained can be applied onto rollers which are required to exhibit a high surface quality and a high mechanical load bearing capacity. The electrolytic deposition of the second nickel layer is preferably carried out in order to be able to produce greater layer thicknesses cost effectively.

Moreover, the articles of the present invention can exhibit a copper layer as metallic layer onto which subsequently a tin or a further copper layer can be applied. Subsequently a gold layer, for example, is applied onto the existing metal layers. Such coatings can be used to EMV protect electronic structural parts or to improve the thermal conductivity of the coated articles, for example.

Articles according to the invention can also exhibit a nickel layer as metallic layer onto which a further nickel layer is applied. It is possible in this way to achieve a high rigidity of the resulting plastic parts, thus guaranteeing an application for components subject to high mechanical stress such as gear wheels, suspensions or housing parts.

Moreover, a copper layer may be present as metallic layer on an article according to the present invention which layer may be coated with a nickel layer and subsequently with a chromium layer. A possible application for such an article consists of using it as a mirror that can be rapidly positioned in copiers and in laser technology.

In a further practical example of the present invention, an epoxy resin can be applied onto a nickel layer deposited without electric current. The surface of this epoxy resin is subsequently once more coated with a nickel layer. In this way, structural parts diffusion-resistant vis-à-vis hydrocarbons even under high pressure for the petrochemical industry can be produced such as e.g. piping and housings capable of completely holding pumps.

An embodiment particularly preferred for industrial purposes consists of filter housings for high frequency components in the telecommunications industry, in particular for transmitter mast units in the mobile radio transmitter sector. These are articles of PPS/PEI whose entire surface is coated first with a nickel/phosphorus alloy applied chemically without electric current in a layer thickness of 6 μm and subsequently with a silver layer applied electrolytically in a thickness of 6 μm.

Previously, such articles were made of aluminium and then nickel coated and finally silver coated. These articles of the state of the art exhibit considerable corrosion problems, in particular in metropolitan areas polluted by waste gas. Previously, these filter housings had to be replaced every 6 months. In the case of the article according to the invention, the period of use, in contrast, can be extended to more than 2 years.

Moreover, these further metallic layers which are applied onto existing metallic layers of the article according to the invention can be applied not only electrolytically but also by means of other processes such as CVD/PVD or thermal spraying onto an article with a metallic coating according to the present invention.

In this way, it is possible to apply aluminium or stainless steel onto an article which consists e.g. of plastic and has been provided with a nickel layer according to the present invention.

A further interesting example of an article according to the invention is a plastic which is provided first with a nickel layer applied without electric current. Onto this nickel layer, layers of silver and gold are subsequently electrolytically applied one after the other. Such a rather specific layer sequence is used in medical technology for structural parts for diagnostic equipment.

Overall, the examples detailed above show that the articles according to the invention can be used in a very large area of technical applications.

An article according to the present invention can, for example, consist of a roller for the sheet product processing industry (films, paper, textiles, printing), a structural part of turbomolecular pumps (ring for the compressor stage), handle for household equipment (saucepans, lids), component for the aeroplane industry (handle, handrail) and the space industry (sun sails), structural part for the electronics industry (condenser, sonic field condenser, sonic rider, microwave hollow-cored conductor, antenna, antenna housing), structural part for the moveable structural parts of cyclones, wind sifters, structural part subject to mechanical, thermal and/or chemical stresses for the motor vehicle industry (brake pistons for motor vehicles) or as a mould or component for the injection moulding industry.

### EXAMPLE (ACCORDING TO THE INVENTION)

A panel of polyamide-6 with the dimensions 200×100×12 mm with an initial roughness of Rₐ=0.64 μm and R_{z}=7.5 μm was surface treated:

The surface pretreatment is carried out with a modified pressure blasting device from Straaltechnik International. The blasting device is operated at a pressure of 4 bar. A boron carbide nozzle with a diameter of 8 mm is used as jet nozzle. The blasting period is 4.6 s. SiC with the granulation P80 with an average grain diameter of 200 to 300 μm is used as blasting agent.

To adjust the blasting system specifically to the requirements of the plastic modification as regards reproducible surface topographies, 2 pressure circuits were installed, one each for transporting the blasting agent and the actual acceleration process respectively. This modification gave a highly constant volume stream and a large pressure range.

A stream of compressed air transports the blasting agent with a pressure as low as possible to the nozzle. The flow conditions guarantee a low wear and tear of the unit and the blasting agent as a result of a high volume stream of the blasting agent and a low proportion of compressed air. Only at the end of the conveying hose in front of the mixing nozzle is the cross section reduced in order to adjust the desired volume stream. In the case of all polymer pretreatments, a constant volume flow of 1 l/min was set. In the second part of the system, compressed air (volume stream 1) flows to the nozzle which can be adjusted steplessly within a pressure range of 0.2-7 bar. The blasting agent which is conveyed into the mixing nozzle at a very low flow rate is then accelerated by the high flow rate of the compressed air stream.

The panel roughened in this way is treated in an ultrasonic bath with a mixture of deionised water and 3% by vol. of butyl glycol for five minutes.

The series of baths used for the metal deposition of the conductive layer are based on the known colloidal palladium activation in association with a final catalysed metal reduction. All bath sequences required for this purpose were purchased from Max Schlötter. The immersion sequences, treatment times and treatment temperatures indicated by the manufacturer were maintained in all the process steps of nickel deposition:

(1) Preliminary activator immersion solution:
This is used to avoid the entrainment of contaminants and to completely wet the specimen before the actual activation of the surface.
Immersion time: 2 min, room temperature

(2) Activator GS 510:
Activation of the surface with tin/palladium colloid.
Immersion time: 4 min, room temperature

(3) Rinsing bath: deionised water
To avoid the entrainment of activator GS 510 components by rinsing in deionised water.
Immersion time: 1 min, room temperature

(4) Conditioner 101:
Conditioning of the material surface by removing undesirable tin compounds from the surface.
Immersion time: 6 min, room temperature

(5) Rinsing bath: deionised water.
Immersion time: 1 min, room temperature

(6a) Chemical nickel bath SH 490 LS:
Metallising of the plastic with a light-coloured, semi-bright amorphous layer at a separation temperature of 88-92° C.
Immersion time: 10 minutes

In the case of the selected immersion time in the nickel bath, a layer thickness of 1.4 μm was obtained. This thickness of the nickel layer is sufficient for an electrolytic coating.

All process steps necessary for depositing the conductive layer took place in a plastic tubs holding 50 l, a bath temperature of 90°±0.5° C. being maintained throughout the entire coating cycle during the nickel deposition by means of an additional hot plate with temperature control. In order to obtain a homogeneous and reproducible layer quality, the series of baths were analysed and supplemented according to information provided by Max Schlötter after putting through 20 specimens.

After chemically applying the conductive nickel layer, the specimen was cooled in distilled water from approximately 90° C. to approximately 60° C. in order to be then coated further electrolytically with nickel at 55° C. This intermediate step had the purpose of avoiding the formation of reaction layers and excluding inherent stresses caused by rapid cooling. The specimens which were coated exclusively with a conductive nickel layer cooled slowly to 25° C. in a distilled water bath.

The microtome section investigations by SEM (1,500 fold and 3,000 fold) are represented in the following figures (FIG. 3).

The evaluation of the EDX analysis gave a residual quantity of calcium of 0.03% by weight.

The results of the adhesive strength investigations are show in Table 1.

TABLE 1

| No. | Adhesive Strength |
|---|---|
| 1 | 20.5 N/mm² |
| 2 | 19.5 N/mm² |
| 3 | 13.4 N/mm² |
| 4 | 16.4 N/mm² |
| 5 | 22.3 N/mm² |
| 6 | 20.3 N/mm² |
| 7 | 16.8 N/mm² |
| 8 | 14.5 N/mm² |
| 9 | 13.2 N/mm² |
| 10 | 12.9 N/mm² |
| 11 | 16.7 N/mm² |
| 12 | 24.5 N/mm² |
| 13 | 18.4 N/mm² |
| 14 | 19.2 N/mm² |
| 15 | 15.4 N/mm² |
| 16 | 22.9 N/mm² |
| 17 | 16.7 N/mm² |
| 18 | 17.3 N/mm² |
| 19 | 12.8 N/mm² |
| 20 | 14.5 N/mm² |
| 21 | 18.2 N/mm² |
| 22 | 19.7 N/mm² |
| 23 | 23.4 N/mm² |
| 24 | 18.9 N/mm² |
| 25 | 20.1 N/mm² |
| 26 | 21.4 N/mm² |
| Standard deviation | 3.4 N/mm² |
| Mean | 18.1 N/mm² |
| Coefficient of variation | 19% |

### Comparative Example (Not According to the Invention)

The example according to the invention is repeated; however, after the blasting treatment the panel is treated in an ultrasonic bath, in a suspension of 5% by weight of CaCO₃ in 96% ethanol for 5 minutes.

Subsequently, the panel is treated in a further ultrasonic bath with pure 96% ethanol for a further five minutes.

The microtome section investigation by SEM (1,500 fold and 3,000 fold) are shown in the following figures (FIG. 4).

The evaluation of the EDX analysis gave me a residual quantity of calcium of 0.91% by weight which originates from the treatement of the CaCO₃/ethanol suspension.

The results of the adhesive strength investigations are shown in Table 2.

TABLE 2

| No. | Adhesive Strength | |
|---|---|---|
| 1 | 9.9 | N/mm² |
| 2 | 19.1 | N/mm² |
| 3 | 10.1 | N/mm² |
| 4 | 13.1 | N/mm² |
| 5 | 16.6 | N/mm² |
| 6 | 10.3 | N/mm² |
| 7 | 19.8 | N/mm² |
| 8 | 13.3 | N/mm² |
| 9 | 21.4 | N/mm² |
| 10 | 10.9 | N/mm² |
| 11 | 20.0 | N/mm² |
| 12 | 10.9 | N/mm² |
| 13 | 11.7 | N/mm² |
| 14 | 13.0 | N/mm² |
| 15 | 16.4 | N/mm² |
| 16 | 14.1 | N/mm² |
| 17 | 15.4 | N/mm² |
| 18 | 10.5 | N/mm² |
| 19 | 15.8 | N/mm² |
| 20 | 16.7 | N/mm² |
| 21 | 8.5 | N/mm² |
| 22 | 17.2 | N/mm² |
| 23 | 7.0 | N/mm² |
| 24 | 18.2 | N/mm² |
| 25 | 7.2 | N/mm² |
| 26 | 19.4 | N/mm² |
| Standard deviation | 4.2 | N/mm² |
| Mean | 14.1 | N/mm² |
| Coefficient of variation | 29.8% | |

The results clearly show a significant difference between the standard deviation of the adhesive strength of the different measured valued points distributed over the surface of the composite material.

During the manufacture of rollers for the printing industry, for example, this difference causes rollers with a coefficient of variation of more than 25% to exhibit local detachments of the metal layer from the roughened plastic substrate during the necessary aftertreatment by grinding which detachments are attributable to low adhesive strengths.

Comparable rollers according to the invention exhibit no detachments during the grinding process.

### LIST OF REFERENCE SYMBOLS OF FIG. 1

(1) Tensile die

(2) Adhesive

(3) Metal layer

(4) Substrate

1. Article whose surface exhibits a composite material, in full or in parts, the composite material consisting of a non-metallic substrate containing at least one polymer, and a metallic layer present thereon and deposited without external current, having an adhesive strength of at least 4 N/mm² characterised in that the boundary layer present between the non-metallic substrate and the metallic layer exhibits a calcium content, determined by EDX analysis of a microtome section, of maximum 0.5% by wt., based on an analysis area of 1×1 μm whose centre runs through the boundary layer.

2. Article according to claim 1 whose surface exhibits a composite material in full or in parts, this composite material exhibiting a first non-metallic layer and a second metallic layer applied thereon characterised in that
a) the surface of the article is not chemically pretreated before the application of the metallic layer; and
b) the metallic layer is not applied by thermal spraying, CVD, PVD or laser treatment.

3. Article according to claim 1 characterised in that the boundary present between the non-metallic substrate and the metallic layer exhibits a roughness with an R_{z} value of maximum 35 μm.

4. Article according to claim 1, characterised in that the non-metallic layer contains at least one fibre-reinforced polymer, in particular a polymer reinforced with carbon fibre and the diameter of the fibre is less than 10 μm.

5. Article according to claim 1 characterised in that the boundary present between the non-metallic substrate and the metallic layer exhibits a roughness with an R_{z} value of maximum 100 μm and that the non-metallic substrate contains at least one fibre-reinforced polymer, in particular a polymer reinforced with glass fibre, and the diameter of the fibre is more than 10 μm.

6. Article according to claim 1 characterised in that the non-metallic substrate is the surface of the article.

7. Article according to claim 1 characterised in that the non-metallic substrate is not the surface of the article.

8. Article according to claim 1 characterised in that the standard deviation of the adhesive strength of the metallic layer at six different measured value points distributed over the surface of the composite material is maximum 25%, in particular maximum 15%, of the arithmetic mean.

9. Article according to claim 1 characterised in that the polymer is selected from the group of polypropylene, polyterafluoroethylene, polyamide, polyethylene, polyvinyl chloride, polystyrene, epoxy resin, polyether ether ketone, polyoxymethylene, polyformaldehyde, polyacetal, polyurethane, polyether imide, polyphenyl sulphone, polyphenylene sulphide, polyarylamide, polycarbonate and polyimide.

10. Article according to claim 1 characterised in that the metal layer deposited without external current is a metal alloy or a metal dispersion layer.

11. Article according to claim 1 characterised in that the metal layer deposited without external current is a copper, nickel or gold layer.

12. Article according claim 10 characterised in that the metal dispersion layer deposited without external current is a copper, nickel or gold layer with embedded non-metallic particles.

13. Article according to claim 12 characterised in that the non-metallic particles exhibit a hardness of more than 1,500 HV and are selected from the group of silicon carbide, corundum, diamond and tetraboron carbide.

14. Article according to claim 12 characterised in that the non-metallic particles exhibit friction-reducing properties and are selected from the group of polytetrafluoroethylene, molybdenum sulphide, cubic boron nitride and tin sulphide.

15. Article according to claim 1 characterised in that, onto the metallic layer deposited without external current, a layer of aluminium, titanium or their alloys is applied whose surface is anodically oxidised or ceramics-treated.

16. Article according to claim 15 characterised in that one or several metallic layers are also arranged between the metallic layer deposited without external current and the layer of aluminium, titanium or its alloys.

17. Article according to claim 15 characterised in that the surface of the article is a ceramic oxide layer of aluminium, titanium or their alloys, which layer is coloured black by foreign ion embedments.

18. Process for the production of an article according to claim 1 comprising the following steps:
i. the surface of the non-metallic layer is not chemically pretreated before applying the metallic layer deposited without electric current;
ii. the surface of the non-metallic layer is microstructured in a first step by a blasting agent;
iii. the metallic layer is subsequently applied by metal deposition without external current.

19. Use of an article according to claim 1 as roller for the sheet product processing industry (films, paper, textiles, printing), a structural part of turbomolecular pumps (ring for the compressor stage), handle for household equipment (saucepans, lids), components for the aeroplane industry (handle, handrail) and the space industry (sun sails), structural part for the electronics industry (condenser, sonic field condenser, sonic rider, microwave hollow-cored conductor, circuit breaker surface, antenna, antenna housing), structural part for the moveable structural parts of cyclones, wind sifters, structural parts subject to mechanical, thermal and/or chemical stresses for the motor vehicle industry (brake pistons for motor vehicles) or as a mould or component for the injection moulding industry.

20. Article according to claim 16 characterised in that the surface of the article is a ceramic oxide layer of aluminium, titanium or their alloys, which layer is coloured black by foreign ion embedments.
